(19) United States
(12) Patent Application Publication
(10) Pub. No.: US 2025/0376872 A1
(43) Pub. Date: Dec. 11, 2025

(54) FENCE TIGHTENING DEVICE

(71) Applicant: Jakob Scott Denning, Sun River, MT (US)

(72) Inventor: Jakob Scott Denning, Sun River, MT (US)

(21) Appl. No.: 18/740,402

(22) Filed: Jun. 11, 2024

(51) Int. Cl. E04H 17/26; B25F 3/00

(52) U.S. Cl. CPC E04H 17/266; B25F 3/00

(57) ABSTRACT

A fence tightening device having a threaded rod that is driven by an impact driver to rotate in a first or a second direction. The threaded rod passes through a central bore in a second bracket that is situated within a first bracket. The threaded rod is contained within a three-sided tube, and the first bracket is configured to surround the three-sided tube and to move along it. The first and second brackets form part of a movable gripping block that is configured to hold a piece of wire and to move along the threaded rod in a first or second direction, depending on the rotation of the threaded rod. Clamping assemblies are located on the movable gripping block and on the nose housing of the impact driver. Planetary gears inside of the impact driver are configured to rotate an anvil on the proximal end of the threaded rod.

### BACKGROUND OF THE INVENTION

### 1. Field of the Invention

The present invention relates generally to the field of fencing, and more particularly, to a fence tightening device.

### 2. Description of the Related Art

The purpose of the present invention is to alleviate the fatigue experienced by operators when maintaining and repairing a wire fence. The present invention ensures that every wire is equally tight, regardless of the operator's strength, and provides better control in achieving the appropriate tightness when stretching the wire. The present invention is structurally distinct from the prior art and includes functional advantages over conventional methods of fence tightening.

U.S. Patent Application Pub. No. 2023/0116633 (Schilleman) discusses various adjustable tensioning devices, including a system for bracing a first elongate member and a second elongate member, the system being comprised of a tensioning device with a first engaging member that is configured to engage with a linking member and a second engaging member that is configured to engage with another linking member. The system further comprises an adjustment member that is structured to selectively control the relative positioning of the first and second engaging members. The tensioning device is positionable along the first and second linking members between the first and second elongate members and is configured to tension the first and second linking members as the first and second engaging members are drawn toward one another by the adjustment member.

U.S. Patent Application Pub. No. 2019/0388956 (Tolley) depicts a wire/chain installing and tensioning device that is made up of a wire-retaining rod, a post-engaging bracket, and a rod-receiving slot. The wire-retaining rod has a rod body, a wire-engagement head, and a torque-receiving head. The wire-engagement head is configured to hold a wire and is rotatably connected around a non-threaded section of the rod body and positioned opposite the wire-engagement head. The threaded section of the rod body is threadably engaged within the rod-receiving slot.

U.S. Pat. No. 8,820,716 (Silver, 2014) discloses a U-shaped cord tightening tool with a saddle on either end of the frame. At the center of the frame is a hook with a swivel mount that secures the cord between the two saddles. A threaded shaft is configured to pull the cord downward, thereby removing slack. Each of the saddles is configured to hold a section of the cord.

U.S. Pat. No. 4,622,722 (Story, 1986) provides a wire gripping apparatus for use with a tensioning device for stretching wire before it is mounted to fence posts. In this invention, an elongated rod has a slotted wire locating plate mounted at its forward end, a support plate extending along the rod, and a clamping member that is movable axially along the rod from its rearward end toward the rear end of the support plate. The wire is secured to the support plate via a slot, and the clamping means is axially movable along the rod toward the rearward end of the support plate, thereby capturing and holding the wire against the rearward end of the support plate.

U.S. Pat. No. 3,620,503 (Bro, 1971) discloses a fence stretch having an elongate member or tube, abutment means slidable on the tube, clamping means that are pivotally attached to the abutment means, a hook that is slidable on the tube, and mechanical means for moving the hook or the abutment along the tube. The invention includes a cradle that is mounted on the abutment means for rotating about an axis perpendicular to the elongated member. The clamping means are mounted on the cradle and configured to clamp a post between the cradle and the clamping means.

U.S. Pat. No. 3,061,302 (Dennis, 1962) shows a combination vice and clamp having parallel side bars formed of angle irons that provide a base for the tool, an end plate that is fixed to one end of the side bars and projects laterally therefrom at substantially right angles to provide a fixed jaw, a second end plate that is fixed to the opposite end of the side bars, and a threaded shaft that is rotatably mounted in the end plates and disposed between the side bars. An actuating means is provided on one end of the shaft, and the movable jaw is slidably mounted on the side bars with a nut that threadedly engages the shaft.

U.S. Pat. No. 3,002,726 (Ford, 1961) describes a device having an elongated hollow rectangular-shaped casing engageable between a fence post and a stretcher bar in a wire fence to be stretched. The casing has side walls and end walls; one of the side walls is slotted, and each of the end walls has a central opening. A threaded shaft extends through the casing and is journalled in the openings in the end walls. An elongated follower block is sleeved around the shaft inside of the casing and threaded to the shaft for movement along the shaft upon rotation of the shaft. The invention incorporates various flanges with dovetailed undercut recesses and dovetailed bases that are removably mounted in and interlocked with the pairs of spaced guide flanges.

U.S. Pat. No. 2,884,225 (Ford, 1959) is similar to the preceding invention in that the '726 patent is a continuation-in-part of the '225 patent. This invention includes means having a detachable connection to the follower block for engaging the stretcher bar and shifting it with the follower block, and means having a detachable connection to the casing and engageable with the post for holding the casing against the post during movement of the follower block. The bar-engaging means has a finger that projects laterally outwardly from the casing to bear against one side of the stretcher bar. The post-engaging means has a pair of hooks that projects laterally outwardly from the casing in the same direction as the finger. The bar-engaging and post-engaging means further comprise guided plates arranged in pairs, with one pair on the follower block and the remaining pairs on opposite walls of the casing. The guide plates of each pair define between them wedging grooves, and the finger and hooks are configured to be wedged into the grooves.

### BRIEF SUMMARY OF THE INVENTION

The present invention is a fence tightening device comprising: a threaded rod; an impact driver that is configured to rotate the threaded rod in a first direction and in a second direction, the impact driver having a nose housing; a three-sided tube having a bottom surface, a first side surface, a second side surface, and an open top, the three-sided tube being configured to contain the threaded rod; a moveable gripping block comprised of: a first bracket that is configured to surround the three-sided tube around the bottom, the first side surface, the second side surface, and the open top of the three-sided tube; a second bracket having a threaded central bore that is configured to receive the threaded rod, the second bracket being situated within the first bracket; a first plate that extends upwardly from a top surface of the first bracket and that is aligned with a longitudinal axis of the threaded rod; and a first clamping assembly that is situated on the first plate and configured to hold and release a fence wire; a second plate that extends upwardly from the nose housing of the impact driver and that is aligned with the longitudinal axis of the threaded rod; and a second clamping assembly that is situated on the second plate and configured to hold and release a fence wire.

In a preferred embodiment, the first clamping assembly comprises: a first clamp having an arcuate edge and a lever, the first clamp being pivotally connected to the first plate; a first stop that is situated on the first plate above the first clamp; and a first spring that is configured to maintain the arcuate edge of the first clamp in direct contact with the first stop; and the second clamping assembly comprises: a second clamp having an arcuate edge and a lever, the second clamp being pivotally connected to the second plate; a second stop that is situated on the second plate above the second clamp; and a second spring that is configured to maintain the arcuate edge of the second clamp in direct contact with the second stop.

In another preferred embodiment, the first plate comprises an inner edge that is perpendicular to a longitudinal axis of the three-sided tube; and the second plate comprises an inner edge that is perpendicular to the longitudinal axis of the three-sided tube. The first plate preferably comprises an outer edge that is at a first angle relative to the longitudinal axis of the three-sided tube; the second plate comprises an outer edge that is at a second angle relative to the longitudinal axis of the three-sided tube; and both the first angle and the second angle are within a range of one hundred ten to one hundred thirty degrees.

In a preferred embodiment, the first plate has a bottom edge with a length and a top edge with a length, and the length of the top edge of the first plate is approximately one-third the length of the bottom edge of the first plate; and the second plate has a bottom edge with a length and a top edge with a length, and the length of the top edge of the second plate is approximately one-third the length of the bottom edge of the second plate. In yet another preferred embodiment, a shaft is driven by a battery-powered motor and configured to engage with a plurality of planetary gears; the plurality of planetary gears is configured to engage with a main gear that is situated inside of a first collar, the first collar being coupled to the nose housing, and the first collar and the main gear being stationary relative to the nose housing; a second collar is configured to fit within the nose housing, and the plurality of planetary gears is configured to cause the second collar to rotate with the planetary gears; and the second collar comprises cutouts that are configured to receive an anvil on a proximal end of the threaded rod, thereby causing the threaded rod to rotate in either the first direction or the second direction, depending on a direction of rotation of the second collar.

### BRIEF DESCRIPTION OF THE DRAWINGS

FIG. 1 is a first perspective view of the present invention illustrating the use of the invention to pull two fence wires together.

FIG. 2 is a second perspective view of the present invention illustrating the use of the invention to pull a wire to a fence post.

FIG. 3 is a third perspective view of the present invention illustrating the use of the invention to pull a gate post to a fence post.

FIG. 4 is a side view of the present invention.

FIG. 5 is a top view of the present invention.

FIG. 6 is a front view of the distal end of the present invention.

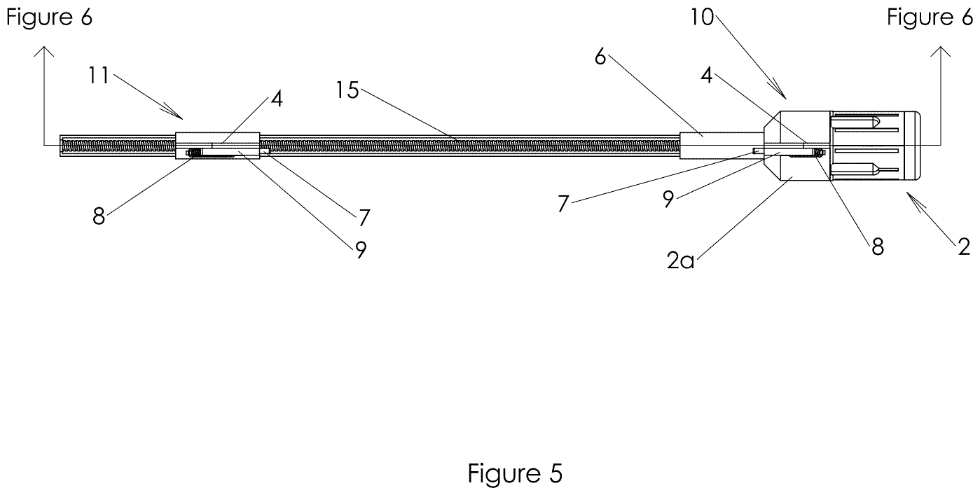

FIG. 5 is a top view of the present invention.

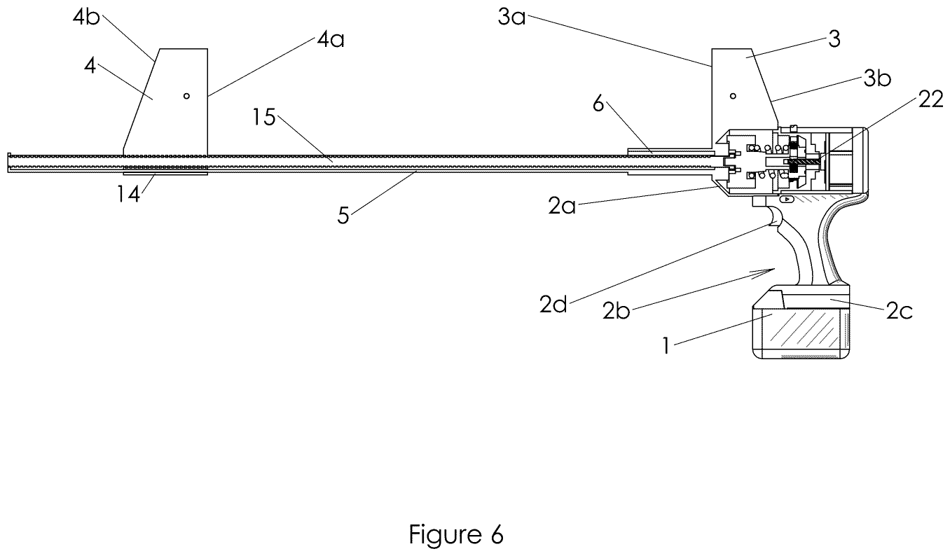

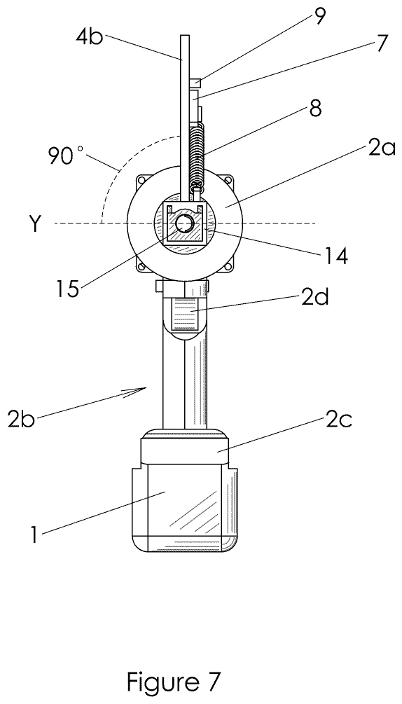

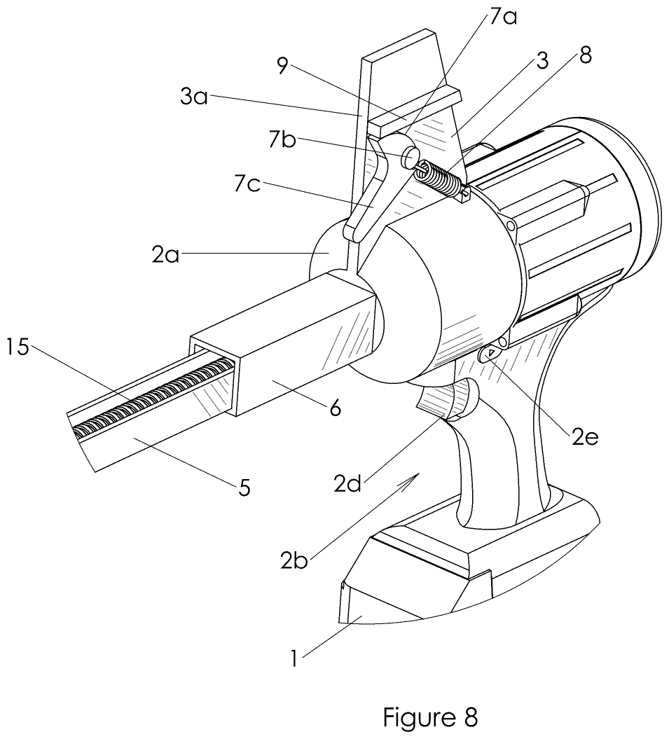

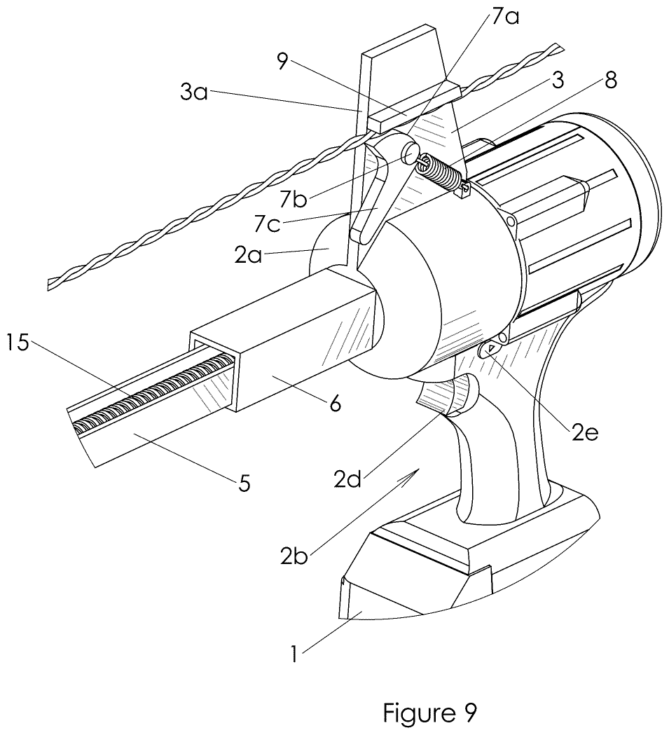

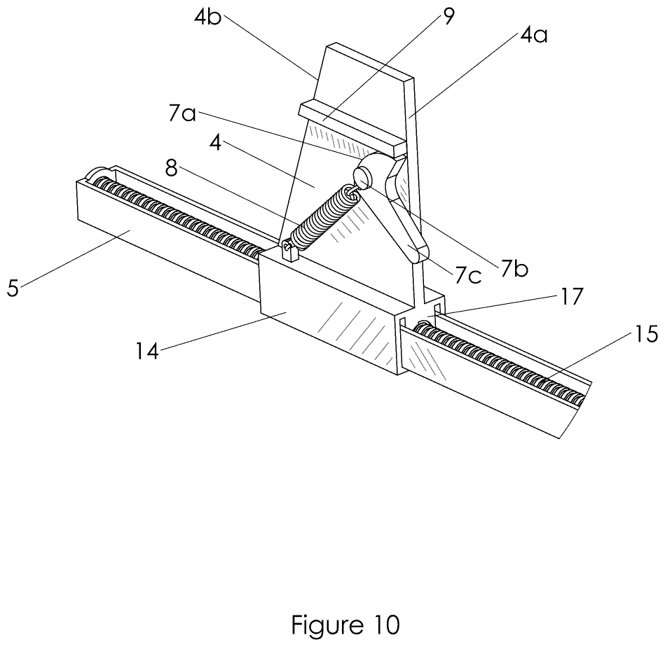

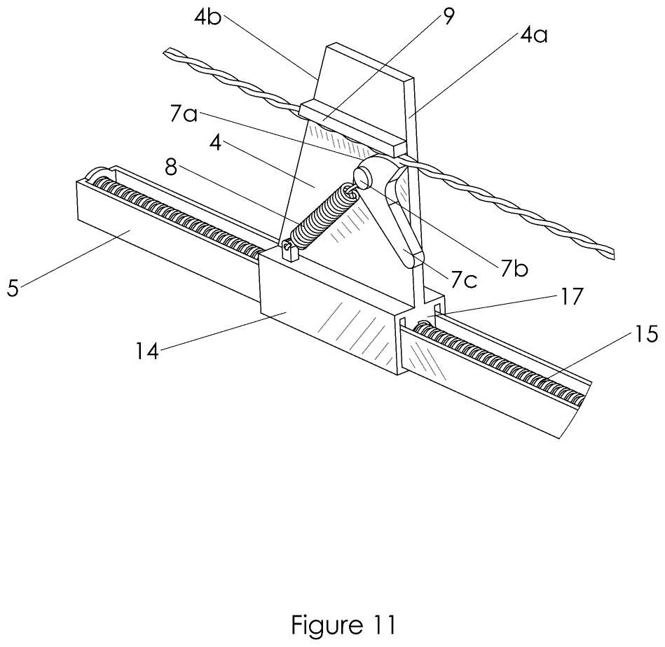

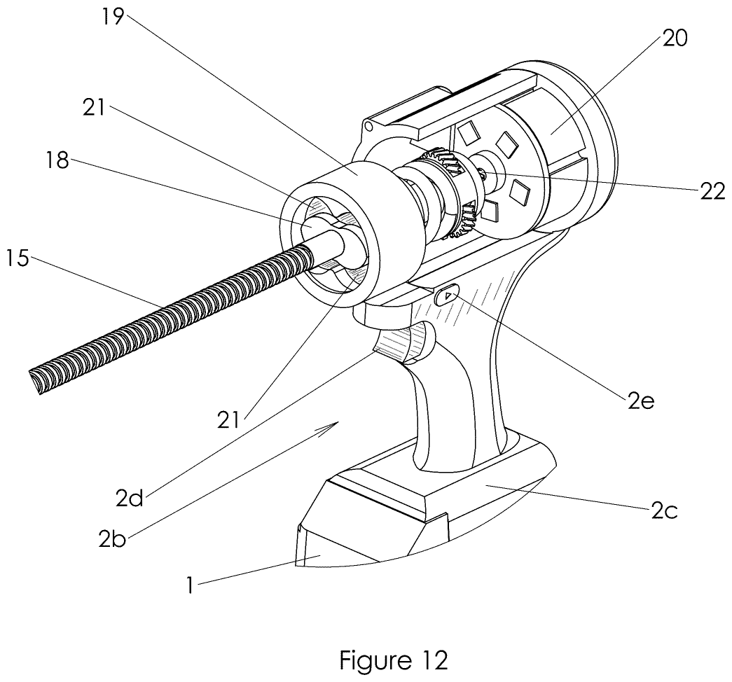

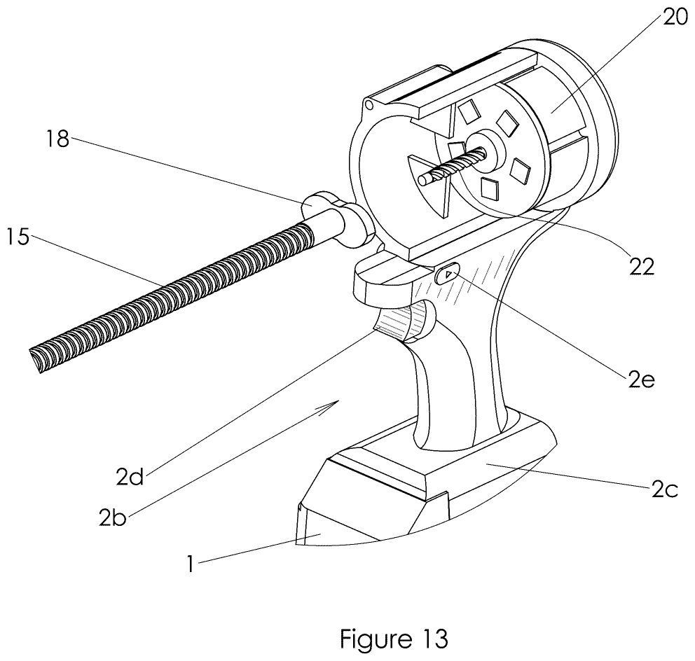

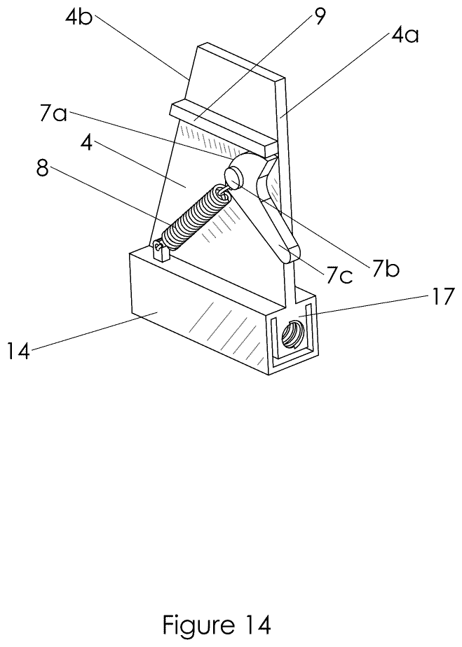

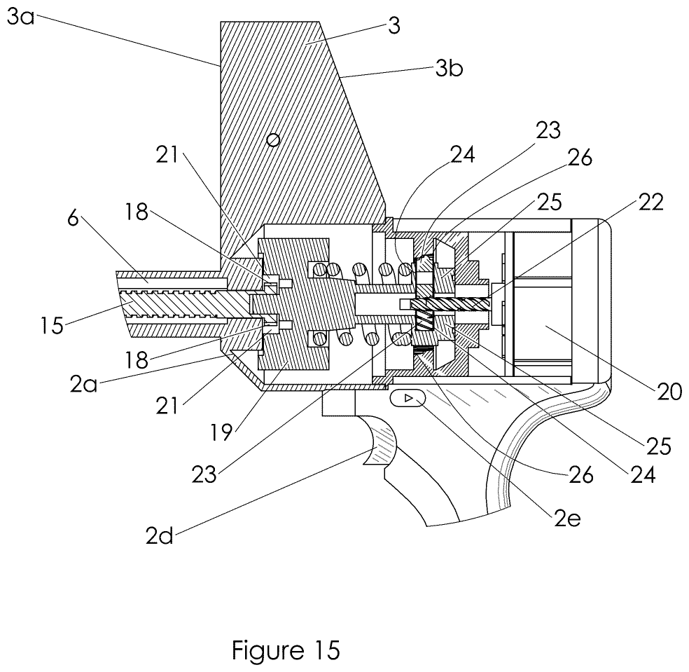

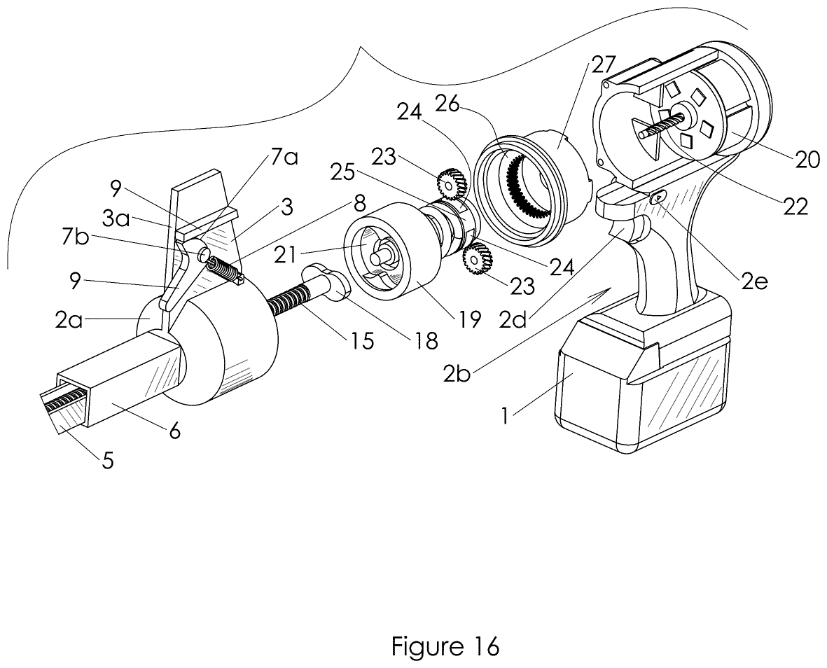

FIG. 6 is a section view of the present invention taken at the line shown in FIG. 5.

FIG. 7 is a front view of the present invention taken at the distal end of the three-sided tube.

FIG. 8 is a detail perspective view of the impact driver end of the present invention.

FIG. 9 is a detail perspective view of the impact driver end of the present invention shown with a wire inserted into the clamp assembly.

FIG. 10 is a detail perspective view of the movable gripping block of the present invention shown with the three-sided tube.

FIG. 11 is a detail perspective view of the movable gripping block of the present invention shown with a wire inserted into the clamp assembly.

FIG. 12 is a perspective view of the impact driver end of the present invention shown with the nose housing removed.

FIG. 13 is a perspective view of the impact driver end of the present invention shown with the rotating cylinder removed.

FIG. 14 is a detail perspective view of the movable gripping block of the present invention shown without the three-sided tube.

FIG. 15 is a section view of the interior parts of the impact driver of the present invention.

FIG. 16 is an exploded view of the interior parts of the impact driver of the present invention.

### REFERENCE NUMBERS

1 Battery
2 Impact driver
2a Drill nose housing
2b Handle (of impact driver)
2c Adapter plate
2d Trigger (of impact driver)
2e Button (on impact driver)
3 First plate
3a First edge (of first plate)
3b Second edge (of first plate)
4 Second plate
4a First edge (of second plate)
4b Second edge (of second plate)
5 Three-sided tube
6 Enclosure
7 Clamp
7a Arcuate/chamfered edge (of clamp)
7b Pivot point (clamp)
7c Lever (of clamp)
8 Spring
9 Stop
10 First clamp assembly
11 Second clamp assembly
12 Fence post
13 Gate post
14 First bracket
15 Threaded rod
16 Wire
17 Second bracket
18 Anvil
19 First collar
20 Electric motor
21 Cutout (on interior of first collar)
22 Motor shaft
23 Planetary gear
24 Slot (in fixture)
25 Fixture
26 Gear
27 Second collar

### DETAILED DESCRIPTION OF INVENTION

### A. Overview

The present invention incorporates a threaded rod that is rotated by an impact driver and fitted to the anvil inside of the drill nose housing. The impact driver is preferably battery-powered. An integrated cable grip tightens the wire as the impact driver rotates the threaded rod, thereby pulling the movable gripping block (which is designed to grip one end of a wire) toward the nose housing. Both the nose housing and the gripping block have a cable grip and an extension spring that is configured to keep the cable grip in a closed position. Angled plates extend from both the nose housing and the movable gripping block.

The movable gripping block is threadably coupled to the threaded rod and configured to move along the threaded rod toward or away from the nose housing, depending on the direction in which the threaded rod is rotated. The invention further comprises a three-sided bar that is configured to protect the threaded rod and counteract rotation of the rod when it is rotating, which allows the gripping block to slide back and forth within the three-sided bar without spinning with the threaded rod.

### B. Detailed Description of the Figures

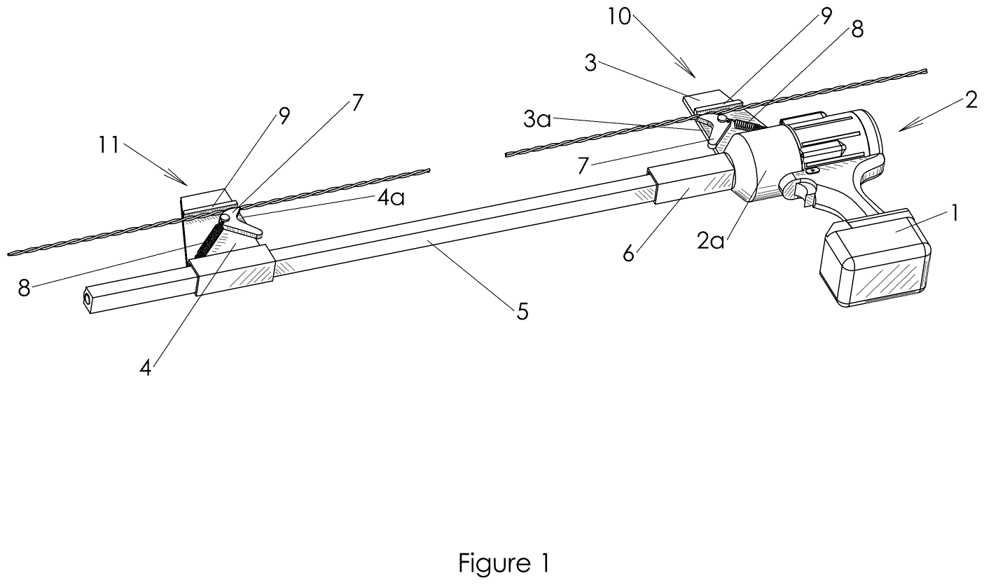

FIGS. 1-3 illustrate three different uses of the present invention. FIG. 1 is a first perspective view of the present invention illustrating the use of the invention to pull two fence wires together. As shown in this figure, the invention is comprised of a battery 1 that is configured to power an impact driver 2. (As used herein, the “impact driver” may be an impact drill or an impact wrench.) The impact driver 2 is coupled to a threaded rod 15 (see FIG. 5). The invention further comprises a first plate 3 and a second plate 4, each of which has a first (inner) edge 3a, 4a that is perpendicular to a longitudinal axis of an elongated three-sided tube 5 that extends forwardly of the drill nose housing 2a. The three-sided tube 5 is configured to enclose the threaded rod 15. Each of the first edges 3a, 4a is configured to face inwardly (that is, toward a center part of the three-sided tube 5). Optionally, the first and second plates 3, 4 may include cutouts (not shown) to reduce weight. The three-sided tube 5 has a proximal end and a distal end. The proximal end of the three-sided tube 5 is connected to an enclosure 6 that couples the proximal end of the three-sided tube 5 to the drill nose housing 2a. The distal end of the three-sided tube 5 is configured to secure a distal end of the threaded rod 15.

Disposed on each of the first and second plates 3, 4 is a clamping assembly comprised of a clamp 7 and a spring 8. The spring 8 is configured to bias or hold the clamp 7 in a closed position against a stop 9. The clamp 7 preferably comprises an arcuate or chamfered edge 7a (see FIG. 8). The first clamp assembly 10 is attached to the first plate 3, which is fixedly attached to the drill nose housing 2a. The second clamp assembly 11 is attached to the second plate 4, which is coupled to the threaded rod 15 and configured to move up and down the three-sided tube 5 as the threaded rod 15 rotates.

In the configuration shown in FIG. 1, a first piece of fence wire has been inserted into the first clamp assembly, and a second piece of fence wire has been inserted into the second clamp assembly. When the impact driver is activated, the threaded rod X rotates, thereby causing the second plate 4 to move relative to the first plate 3. Depending on the direction in which the threaded rod X rotates, the first plate 3 moves either closer to or further away from the second plate 4. In this manner, one piece of fence wire can be brought closer to the second piece of wire, and the operator can manually secure the two pieces of fence wire together before opening the clamps 7 to remove the pieces of wire from the clamp assemblies 10, 11.

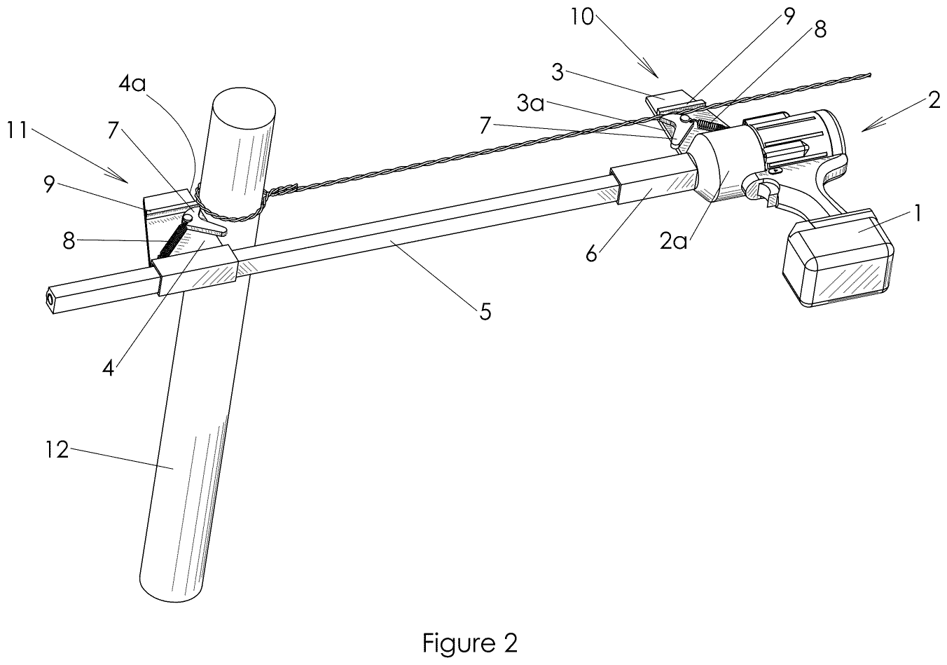

FIG. 2 is a second perspective view of the present invention illustrating the use of the invention to pull a wire to a fence post. In this configuration, a piece of wire has been inserted into the first clamp assembly 10, and the second plate 4 is positioned so that the first edge 4a abuts up against the outside of a fence post 12. When the impact driver 2 is activated in a first direction, the second plate 4 moves toward the first plate 3, thereby pulling the piece of wire closer to the fence post and removing slack in the fence wire. Once the fence wire has been suitably tightened, the operator can manually secure the fence wire in the desired position.

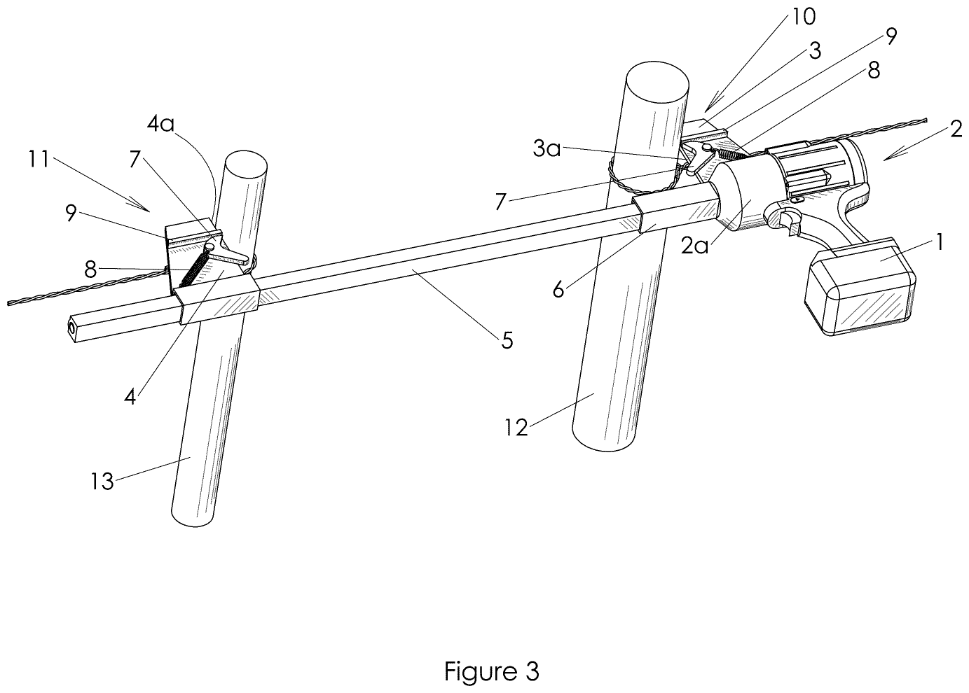

FIG. 3 is a third perspective view of the present invention illustrating the use of the invention to pull a gate post to a fence post. In this configuration, the first edge 3a of the first plate 3 is positioned so that it abuts up against the outside of a fence post, and the first edge 4a of the second plate 4 is positioned so that it abuts up against the outside of a gate post 13. When the impact drill 2 is activated in a first direction, the second plate 4 moves toward the first plate 3, thereby pulling the gate post 13 to the fence post 14 and facilitating closure of the gate.

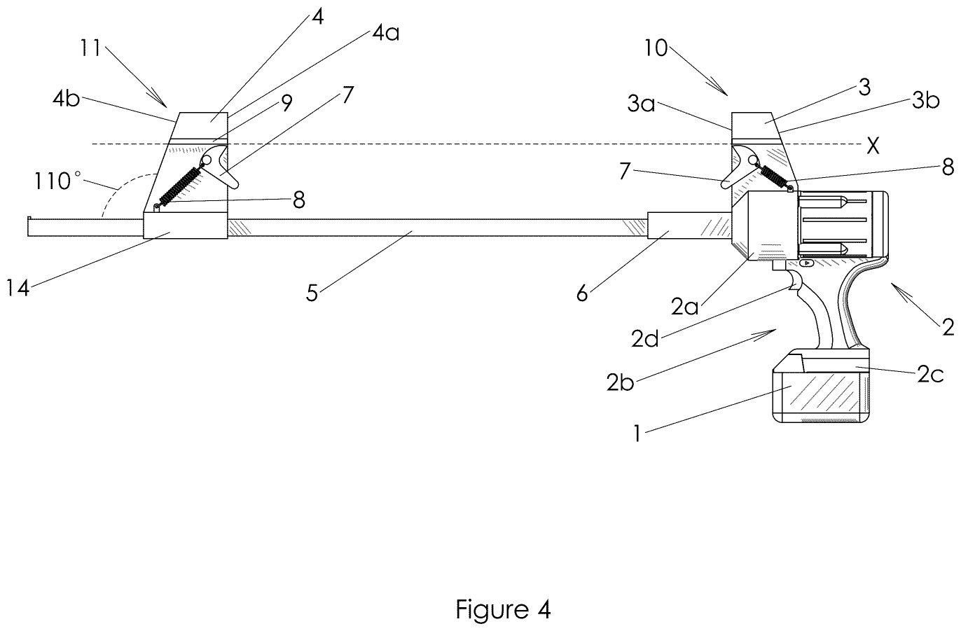

FIG. 4 is a side view of the present invention. As shown in this figure, the impact driver 2 preferably comprises a handle 2b with an adapter plate 3c, which connects the battery 1 to the impact driver 2. The battery 1 is preferably rechargeable, and the impact driver 2 is driven by an electric motor 20 that is contained within the drill housing (see FIG. 12). As shown here, the two clamping assemblies 10, 11 are preferably configured to be on the same horizontal plane, as shown by the dotted line (designated as “X) in FIG. 4. The second plate 4 extends upwardly from a first bracket 14 that surrounds the three-sided tube 5 and is configured to move toward or away from the enclosure 6 at the proximal end of the threaded rod 15, as explained more fully below.

FIG. 5 is a top view of the present invention, and FIG. 6 is a section view of the present invention taken at the line shown in FIG. 5. These two figures show the threaded rod 15, the proximal end of which is coupled to the motor shaft 22 (see FIGS. 12 and 13) so that when the impact driver 2 is activated in a first direction, the threaded rod 15 rotates in a first direction, and when the impact driver 2 is activated in a second direction, the threaded rod 15 rotates in a second direction. The threaded rod 15 extends the entire length of the three-sided tube 5 and of the enclosure 6. The enclosure 6 provides added structural support to the invention at the front end of the impact driver 2.

FIG. 7 is a front view of the present invention taken at the distal end of the three-sided tube. As shown in this figure, the impact driver 2 preferably comprises a trigger 2d for activating the impact driver. The impact driver 2 also preferably comprises a button 2e (see FIG. 8) on either side of the impact driver that can be pushed in on one side of the drill or the other to determine the direction in which the threaded rod 15 rotates. In an alternate embodiment, the impact driver 2 comprises a double trigger that enables the operator to rotate the threaded rod 5 in opposite directions. Each of the first and second plates 3, 4 comprises a second (outer) edge 3b, 4b that is at an angle relative to the longitudinal axis of the three-side tube 5 (see FIG. 4). In a preferred embodiment, this angle is in the range of one hundred ten (110) to one hundred thirty (130) degrees. The reason that the outer edge 3b, 4b is angled is to reduce weight as compared to a rectangular-shaped plate, and the angle is preferably no greater than one hundred thirty-five (135) degrees because any greater angle would not provide sufficient space on which to attach the clamping assembly. In a preferred embodiment, for each of the first and second plates 3,4, the length of the plate at the bottom of the plate is approximately equal to the length of the nose housing (front to back), and the length of the plate at the top of the plate is approximately one-third the length of the plate at the bottom of the plate. Note that the first and second plates 3, 4 are at a ninety-degree (90°) angle relative to the lateral axis of the device, as indicated in FIG. 7.

FIG. 8 is a detail perspective view of the impact driver end of the present invention, and FIG. 9 is a detail perspective view of the impact driver end of the present invention shown with a wire inserted into the clamp assembly. As shown in these two figures, the clamping assembly 10 is comprised of a clamp 7 that is pivotally attached to the first plate 3 at pivot point 7b. The wire 16 is held between the arcuate edge 7a of the clamp 7 and the stop 9, which is in the form of a ledge positioned on the first plate 3 directly above the tip of the clamp 7. The clamp 7 is opened and shut by placing manual pressure on the lever 7c of the clamp. The clamping assembly 11 on the second plate 4 is similarly constructed.

FIG. 10 is a detail perspective view of the movable gripping block of the present invention, and FIG. 11 is a detail perspective view of the movable gripping block of the present invention shown with a wire inserted into the clamp assembly. As shown in this figure, the first plate extends upwardly from a top surface of the bracket 14, which is configured to surround and move slidably along the three-sided tube 5. Inside of the first bracket 14 is a second bracket 17 that is square in shape and configured to fit within the three-sided tube 5. The second bracket 17 has a threaded central bore through which the threaded rod 15 extends. In this manner, as the threaded rod 15 is rotated, the second bracket 17 moves along the threaded rod 15 in one direction or the other, depending on the direction of rotation of the threaded rod 15. The direction of rotation of the threaded rod 15 is determined by the impact driver 2. Note that the top of the second bracket 17 is attached to and extends downwardly from the top first bracket 14, as shown. See also FIG. 14.

FIG. 12 is a perspective view of the impact driver end of the present invention shown with the nose housing removed, and FIG. 13 is a perspective view of the impact driver end of the present invention shown with the rotating cylinder (or collar) removed. As shown in these two figures, an anvil 18 is preferably attached to the threaded rod 15 at the proximal end of the threaded rod. The anvil 18 is positioned within a first collar 19 that is situated inside of the drill nose housing 2a and configured to rotate along with the motor shaft 22. In a preferred embodiment, the anvil 18 fits within a cutout 22 on the interior of the first collar 19. The present invention is not limited to any particular manner of connecting the threaded rod 15 to the motor shaft 22, as long as the threaded rod 15 is configured to rotate in two opposing directions, depending on the direction of rotation of the motor shaft 22.

FIG. 15 is a section view of the interior parts of the impact driver of the present invention, and FIG. 16 is an exploded view of the interior parts of the impact driver of the present invention. As shown in these figures, the motor shaft 22 engages with three planetary gears 23 (only two of which are visible in FIG. 16). Because FIG. 16 is an exploded view, the planetary gears 23 have been moved radially out of the slots 24 in the fixture 25 into which they fit when the impact driver 2 is fully assembled. The planetary gears 23 in turn engage with a gear 26 inside of a second collar 27. All of these parts are shown in section view in FIG. 15.

The advantages of the present invention include the fact that it is portable and runs on battery power. The present invention minimizes risk of injury to the operator by eliminating the need for any other hand tools. It is superior to conventional methods of fixing broken wires, tightening loose wires, and opening/closing wire gates because it is self-contained and does not require chains or any other equipment to operate. Finally, the present invention affords the user greater control over the degree to which the wires are tightened.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. A fence tightening device comprising:
(a) a threaded rod;
(b) an impact driver that is configured to rotate the threaded rod in a first direction and in a second direction, the impact driver having a nose housing;
(c) a three-sided tube having a bottom surface, a first side surface, a second side surface, and an open top, the three-sided tube being configured to contain the threaded rod;
(d) a moveable gripping block comprised of:
a first bracket that is configured to surround the three-sided tube around the bottom, the first side surface, the second side surface, and the open top of the three-sided tube;
a second bracket having a threaded central bore that is configured to receive the threaded rod, the second bracket being situated within the first bracket;
a first plate that extends upwardly from a top surface of the first bracket and that is aligned with a longitudinal axis of the threaded rod; and
a first clamping assembly that is situated on the first plate and configured to hold and release a fence wire;
(e) a second plate that extends upwardly from the nose housing of the impact driver and that is aligned with the longitudinal axis of the threaded rod; and
(f) a second clamping assembly that is situated on the second plate and configured to hold and release a fence wire.

2. The fence tightening device of claim 1, wherein the first clamping assembly comprises:
a first clamp having an arcuate edge and a lever, the first clamp being pivotally connected to the first plate;
a first stop that is situated on the first plate above the first clamp; and
a first spring that is configured to maintain the arcuate edge of the first clamp in direct contact with the first stop; and
wherein the second clamping assembly comprises:
a second clamp having an arcuate edge and a lever, the second clamp being pivotally connected to the second plate;
a second stop that is situated on the second plate above the second clamp; and
a second spring that is configured to maintain the arcuate edge of the second clamp in direct contact with the second stop.

3. The fence tightening device of claim 1, wherein the first plate comprises an inner edge that is perpendicular to a longitudinal axis of the three-sided tube; and
wherein the second plate comprises an inner edge that is perpendicular to the longitudinal axis of the three-sided tube.

4. The fence tightening device of claim 3, wherein the first plate comprises an outer edge that is at a first angle relative to the longitudinal axis of the three-sided tube;
wherein the second plate comprises an outer edge that is at a second angle relative to the longitudinal axis of the three-sided tube; and
wherein both the first angle and the second angle are within a range of one hundred ten to one hundred thirty degrees.

5. The fence tightening device of claim 1, wherein the first plate has a bottom edge with a length and a top edge with a length, and the length of the top edge of the first plate is approximately one-third the length of the bottom edge of the first plate; and
wherein the second plate has a bottom edge with a length and a top edge with a length, and the length of the top edge of the second plate is approximately one-third the length of the bottom edge of the second plate.

6. The fence tightening device of claim 1, wherein a shaft is driven by a battery-powered motor and configured to engage with a plurality of planetary gears;
wherein the plurality of planetary gears is configured to engage with a main gear that is situated inside of a first collar, the first collar being coupled to the nose housing, and the first collar and the main gear being stationary relative to the nose housing;
wherein a second collar is configured to fit within the nose housing, and the plurality of planetary gears is configured to cause the second collar to rotate with the planetary gears; and
wherein the second collar comprises cutouts that are configured to receive an anvil on a proximal end of the threaded rod, thereby causing the threaded rod to rotate in either the first direction or the second direction, depending on a direction of rotation of the second collar.
